(19) United States
(12) Patent Application Publication
(10) Pub. No.: US 2018/0277824 A1
(43) Pub. Date: Sep. 27, 2018

(54) SECONDARY BATTERY AND MANUFACTURING METHOD THEREFOR

(71) Applicant: CONTEMPORARY AMPEREX TECHNOLOGY CO., LIMITED, Ningde (CN)

(72) Inventors: Wei LI, Ningde (CN); Hongjiang YU, Ningde (CN)

(21) Appl. No.: 15/997,434

(22) Filed: Jun. 4, 2018

Related U.S. Application Data
(63) Continuation of application No. PCT/CN2015/099442, filed on Dec. 29, 2015.

(51) Int. Cl. H01M 2/34; H01M 2/08; H01M 2/04; H01M 2/30

(52) U.S. Cl. CPC H01M 2/345; H01M 2/348; H01M 2/08; H01M 2200/103; H01M 2/30; H01M 2200/20; H01M 2/0486

(57) ABSTRACT

The present disclosure provides a secondary battery and a manufacturing method therefore. The secondary battery comprises a case, an electrode assembly and a cap assembly. The case has four side walls and a bottom wall which enclose an internal space; the electrode assembly is received in the internal space of the case. The cap assembly is provided to a top of the case and seals the electrode assembly in the internal space; the cap assembly comprises a safety mechanism configured to make an electrical current not flow through the electrode assembly when a gas pressure in the internal space reaches a predetermined value. At least one of the four side walls of the case bulges outwardly, and the internal space protrudes correspondingly. The secondary battery according to the present disclosure can provide an expanding space for an electrode plate of the electrode assembly, avoid the electrode plate being fractured by the internal pressure, prevent the electrolyte being squeezed out of the electrode assembly and avoid the infiltration capability of the electrode assembly decreasing, reduce risk of short circuit of the secondary battery, slow down the decay of cycle performance and prevent the diving of cycle performance, improve service life of the secondary battery. At the same time, the secondary battery also can avoid the gas-pressure type safety mechanism of the secondary battery being actuated in the normal state and prevent failure.

### FIELD OF THE PRESENT DISCLOSURE

The present disclosure relates to the field of battery, and particularly relates to a secondary battery and a manufacturing method therefor.

### BACKGROUND OF THE PRESENT DISCLOSURE

FIG. 1 is a schematic view of an existing secondary battery.

Referring to FIG. 1, in the process of the use of the existing secondary battery, an electrode plate gradually expands, the expanding force subjected by an electrode assembly 2 increases; because the electrode assembly 2 is constrained by a case 11, the pressure subjected by main surfaces of the electrode assembly 2 (the surfaces of the electrode assembly 2 face side walls 11 in an up-down direction shown in FIG. 1) from the case 1 increases, which will increase the stretching force at a corner P of the electrode assembly 2, easily lead to the electrode plate being fractured and result in large risk of short circuit of the electrode assembly 2. At the same time, that the electrode plate gradually expands causes the internal gas pressure of the case 11 to be increased, which will actuate a gas-pressure type safety mechanism (not shown) of the secondary battery, interrupt a circuit between the electrode assembly and an external electrical device, and lead to a failure of the secondary battery in the normal state.

In addition, as the expanding force increases, electrolyte in the electrode assembly 2 is gradually squeezed out, which will decrease infiltration capability of the electrode assembly 2. When the expanding force reaches a predetermined value, it will lead to decay of cycle performance of the secondary battery accelerating, and even diving.

### SUMMARY OF THE PRESENT DISCLOSURE

In view of the problem existing in the background, an object of the present disclosure is to provide a secondary battery and a manufacturing method therefor, which can provide a sufficient expanding space for the electrode plate of the electrode assembly, avoid the electrode plate being fractured by the internal pressure, prevent the electrolyte being squeezed out of the electrode assembly and avoid the infiltration capability of the electrode assembly decreasing, reduce risk of short circuit of the secondary battery, slow down the decay of the cycle performance of the secondary battery and prevent the diving of the cycle performance, improve the service life of the secondary battery.

Another object of the present disclosure is to provide a secondary battery and a manufacturing method therefore, which can avoid the gas-pressure type safety mechanism of the secondary battery being actuated in the normal state and prevent failure of the secondary battery.

In order to achieve the above object, in a first aspect, the present disclosure provides a secondary battery, which comprises a case, an electrode assembly and a cap assembly. The case has four side walls and a bottom wall which enclose an internal space; the electrode assembly is received in the internal space of the case. The cap assembly is provided to a top of the case and seals the electrode assembly in the internal space; the cap assembly comprises a safety mechanism configured to make an electrical current not flow through the electrode assembly when a gas pressure in the internal space reaches a predetermined value. At least one of the four side walls of the case bulges outwardly, and the internal space protrudes correspondingly.

In order to achieve the above object, in a second aspect, the present disclosure provides a manufacturing method for secondary battery, which comprises steps of: putting the electrode assembly into the internal space of the case enclosed by the four side walls and the bottom wall of the case; providing the cap assembly to the top of the case and sealing the electrode assembly in the space of the case; before sealing the electrolyte injection hole of the cap assembly of the secondary battery, injecting an inert gas into the internal space of the case via the electrolyte injection hole and establishing a constant gas pressure in the internal space; keeping a period of time, making a corresponding side wall of the case bulge outwardly and the space protrude correspondingly.

In order to achieve the above object, in a third aspect, the present disclosure provides a manufacturing method for secondary battery, which comprises steps of: putting the electrode assembly into the internal space of the case enclosed by the four side walls and the bottom wall of the case; providing the cap assembly to the top of the case and sealing the electrode assembly in the internal space of the case; after sealing the electrolyte injection hole of the cap assembly of the secondary battery, placing the secondary battery into a negative pressure box; keeping a period of time under a constant pressure, making a corresponding side wall of the case bulge outwardly and the space protrude correspondingly.

The present disclosure has the following beneficial effects.

In the secondary battery according to the present disclosure, an electrode plate of the electrode assembly expands in the process of use; the internal space receiving the electrode assembly protrudes outwardly, which can provide a sufficient expanding space for the electrode plate, alleviate an internal pressure between the electrode plate and the side wall of the case, avoid the electrode plate being fractured by the internal pressure, prevent the electrolyte being squeezed out of the electrode assembly and avoid the infiltration capability of the electrode assembly decreasing, reduce risk of short circuit of the secondary battery, slow down the decay of the cycle performance and prevent the diving of the cycle performance, improve the service life of the secondary battery. At the same time, the internal space protruding outwardly also can prevent the increase of the gas pressure caused by the expansion of the electrode plate, which can avoid the safety mechanism of the secondary battery being actuated in the normal state and prevent failure of the secondary battery.

In the manufacturing method for secondary battery, the constant gas pressure in the internal space of the case can be established by injecting the inert gas, the corresponding side wall of the case bulges outwardly under the influence of the internal gas pressure, and the internal space protrudes correspondingly, so that the secondary battery according to the first aspect of the present disclosure is obtained. Because the gas pressure applied on the side wall is uniform, a convex surface of the side wall is smooth and uniform.

In the manufacturing method for secondary battery, the sealed secondary battery is positioned in the negative pressure box and kept under the constant pressure, so a force is applied on the corresponding side wall due to the difference between the gas pressure in the case and the gas pressure outside the case, which makes the corresponding side wall of the case bulge outwardly and makes the internal space protrude correspondingly, so that the secondary battery according to the first aspect of the present disclosure is obtained. The force applied on the corresponding side wall due to the difference between the gas pressure in the case and the gas pressure outside the case is uniform, so the convex surface of the side wall is smooth and uniform.

### BRIEF DESCRIPTION OF THE FIGURES

FIG. 1 is a schematic view of an exiting secondary battery.

FIG. 2 is a top view of a secondary battery according to the present disclosure.

FIG. 3 is a front view of the secondary battery of FIG. 2.

FIG. 4 is a cross sectional view taken along a line A-A of the secondary battery of FIG. 2.

FIG. 5 is a cross sectional view taken along a line B-B of an embodiment of the secondary battery of FIG. 2.

FIG. 6 is a cross sectional view taken along the line B-B of another embodiment of the secondary battery of FIG. 2.

FIG. 7 is an enlarged view of a part of FIG. 6 surrounded by a circle.

FIG. 8 is a cross sectional view taken along the line B-B of still another embodiment of the secondary battery of FIG. 2.

FIG. 9 is a top view of a case of the secondary battery of FIG. 3.

FIG. 10 is a cross sectional view taken along a line D-D passing through a protruding point of the secondary battery of FIG. 3 with an electrode assembly removed for the sake of clarity.

FIG. 11 is a top view of a case of another embodiment corresponding to FIG. 9.

FIG. 12 is a cross sectional view of FIG. 11.

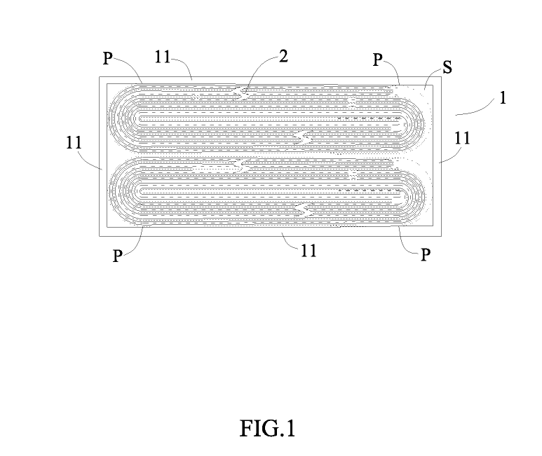

Reference numerals in figures are represented as follows:
1 case
11 side wall
111 edge portion
112 bulging portion
1121 protruding point
12 bottom wall
S internal space
2 electrode assembly
3 cap assembly
31 safety mechanism
311A inversion plate
311B inversion plate
312 conductive plate
3121 notch
313 fuse
32 conductive cap plate
33 first electrode terminal
34 second electrode terminal
35 electrolyte injection hole
W width
C convexity
P corner

### DETAILED DESCRIPTION

Hereinafter a secondary battery and a manufacturing method therefor according to the present disclosure will be described in detail in combination with the figures.

Firstly, a secondary battery according to a first aspect of the present disclosure will be described.

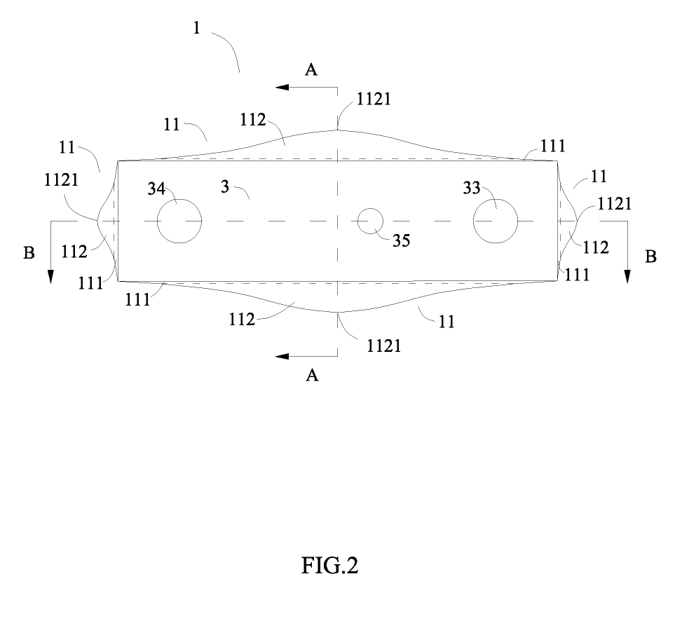

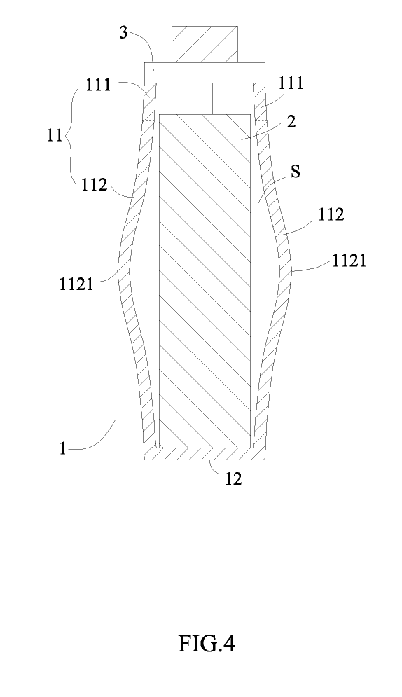

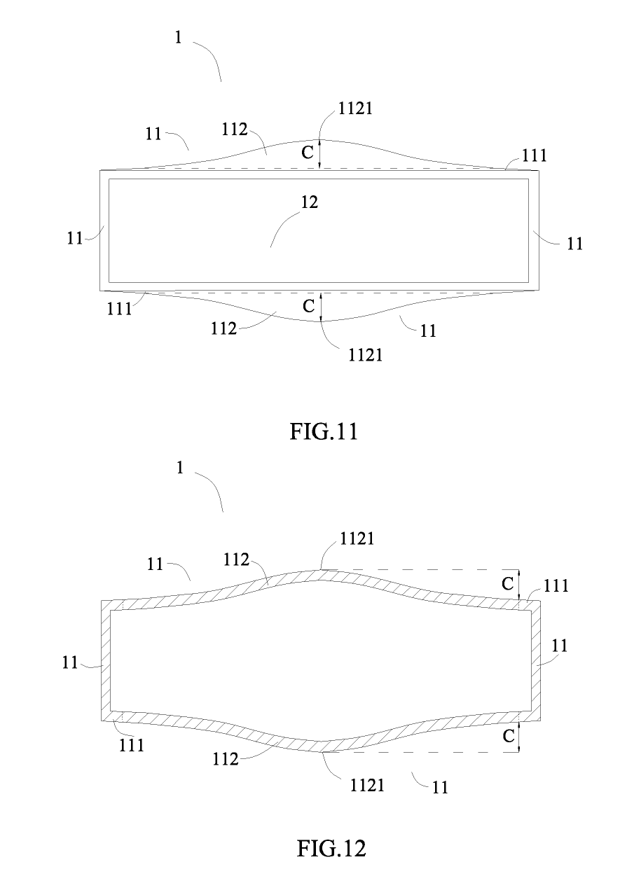

Referring to FIG. 2 to FIG. 12, a secondary battery according to the present disclosure comprises a case 1, an electrode assembly 2 and a cap assembly 3. The case 1 has four side walls 11 and a bottom wall 12 which enclose an internal space S; the electrode assembly 2 is received in the internal space S of the case 1. The cap assembly 3 is provided to a top of the case 1 and seals the electrode assembly 2 in the internal space S; the cap assembly 3 comprises a safety mechanism 31 configured to make an electrical current not flow through the electrode assembly 2 when a gas pressure in the internal space S reaches a predetermined value. At least one of the four side walls 11 of the case 1 bulges outwardly, and the internal space S protrudes correspondingly.

In the secondary battery according to the present disclosure, an electrode plate (not shown) of the electrode assembly 2 expands in the process of use; the internal space S receiving the electrode assembly 2 protrudes outwardly, which can provide a sufficient expanding space for the electrode plate, alleviate an internal pressure between the electrode plate and the side wall 11 of the case 1, avoid the electrode plate being fractured by the internal pressure, prevent the electrolyte being squeezed out of the electrode assembly 2 and avoid the infiltration capability of the electrode assembly 2 decreasing, reduce risk of short circuit of the secondary battery, slow down the decay of the cycle performance and prevent the diving of the cycle performance, improve the service life of the secondary battery. At the same time, the internal space S protruding outwardly also can prevent the increase of the gas pressure caused by the expansion of the electrode plate (not shown), which can avoid the safety mechanism 31 of the secondary battery being actuated in the normal state and prevent failure of the secondary battery.

In an embodiment of the secondary battery according to the present disclosure, referring to FIGS. 2-6 and FIGS. 8-12, the side wall 11 of the case 1 bulging outwardly has an edge portion 111 positioned at a periphery of the side wall 11 and a bulging portion 112 encircled by the edge portion 111.

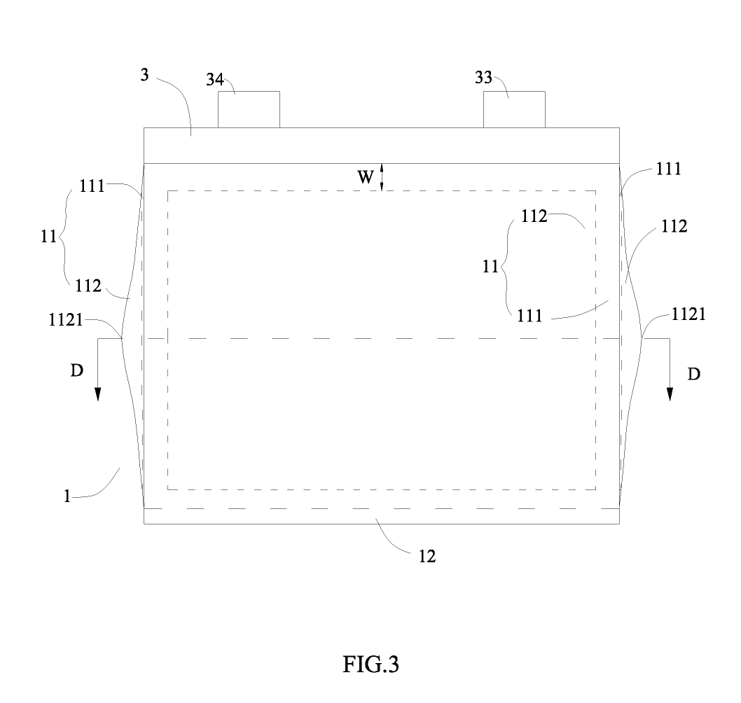

In an embodiment of the secondary battery according to the present disclosure, referring to FIG. 3, the edge portion 111 is in a shape of rectangular annulus with a constant width W. In an embodiment, the width of the edge portion 111 is 5 mm.

In an embodiment of the secondary battery according to the present disclosure, referring to FIGS. 2-6 and FIGS. 8-12, a protruding point 1121 of the bulging portion 112 of the side wall 11 bulging outwardly in the case 1 is positioned in a centre of the bulging portion 112. It should be noted that, the protruding point 1121 can be a central point of the bulging portion 112 of the side wall 11 or a point positioned in a central area around the central point of the bulging portion 112 of the side wall 11.

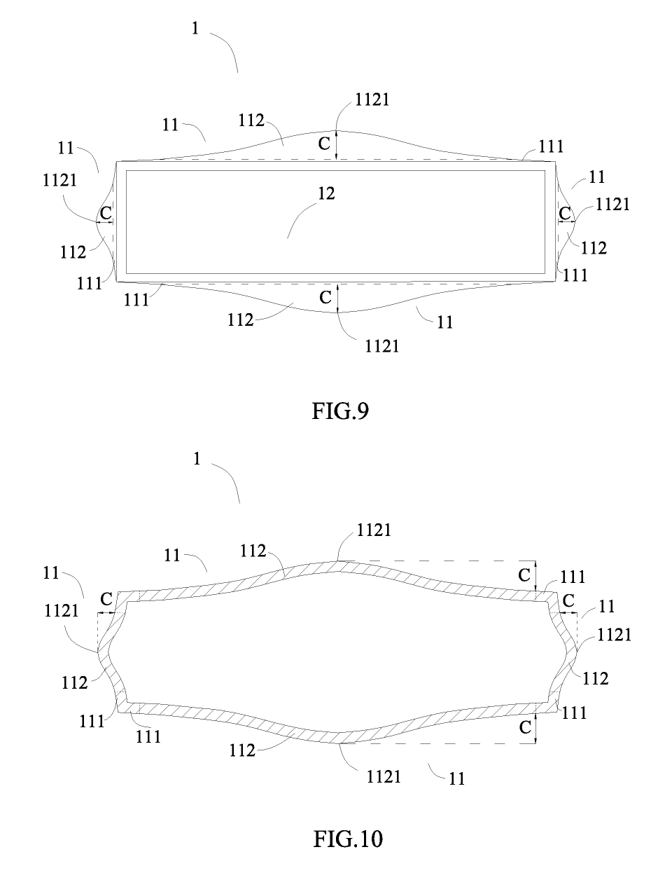

In an embodiment of the secondary battery according to the present disclosure, referring to FIGS. 9-12, a perpendicular distance between the protruding point 1121 and a plane defined by a boundary between the bulging portion 112 and the edge portion 111 is defined as convexity C, the convexity C can range from 0.1 mm to 3 mm. It should be noted that, for sake of convenience in measuring, the convexity C of the corresponding side wall 11 bulging outwardly can be measured from the outside of the case 1, so as to indirectly reflect the protruding degree of the internal space S.

In an embodiment of the secondary battery according to the present disclosure: scanning coordinates of all points of the side wall 11 bulging outwardly in the case 1 by a plane measuring instrument, inputting data of the coordinates of the points to a computer (the plane measuring instrument is set according to the width of the edge portion) and removing the data of the coordinates of the points of the edge portion 111; then fitting a curved surface from the obtained data, and obtaining a height difference between a highest point of the curved surface and a lowest point of the curved surface, the height difference is the convexity C of the side wall 11; verifying whether the convexity C is within an allowable scope of the battery. The plane measuring instrument can be a battery planeness measuring instrument made by ZHENGYE TECHNOLOGY, and model of which is ASIDA-PM1000.

In an embodiment of the secondary battery according to the present disclosure, referring to FIGS. 2-6 and FIGS. 8-12, at least two of the four side walls 11 of the case 1 bulge outwardly.

In an embodiment of the secondary battery according to the present disclosure, a difference between convexities C of any two side walls 11 bulging outwardly in the case 1 is less than 0.5 mm.

In an embodiment of the secondary battery according to the present disclosure, a thickness of the side wall 11 of the case 1 ranges from 0.05 mm to 3 mm.

In an embodiment of the secondary battery according to the present disclosure, the electrode assembly 2 is a wound-type electrode assembly, a laminated-type electrode assembly or a wound-laminated-combined type electrode assembly.

In an embodiment of the secondary battery according to the present disclosure, referring to FIGS. 2-4 and FIGS. 9-12, two of the four side walls 11 of the case 1 which are opposite to each other and larger than the other two of the four side walls 11 of the case 1 bulge outwardly.

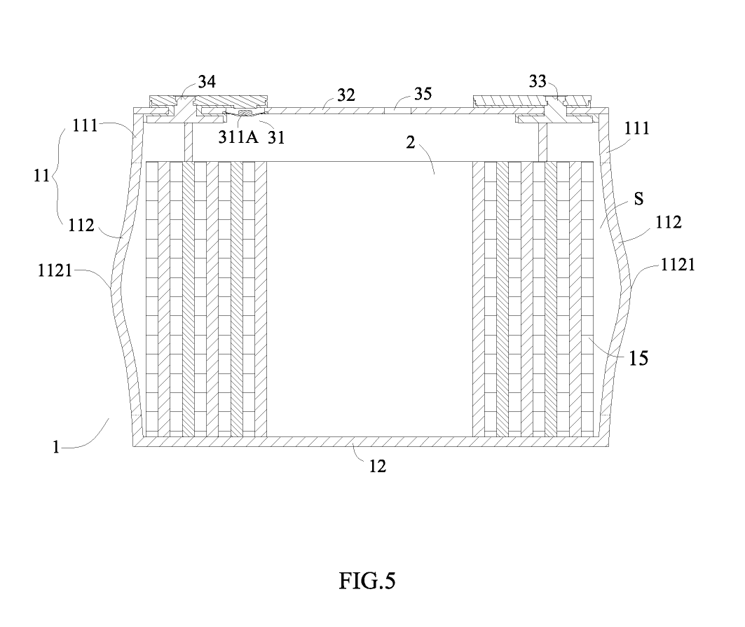

In an embodiment of the secondary battery according to the present disclosure, referring to FIG. 5, the cap assembly 3 further comprises: a conductive cap plate 32; a first electrode terminal 33 electrically connected with the electrode assembly 2 and the conductive cap plate 32; and a second electrode terminal 34 opposite to the first electrode terminal 33 in polarity, electrically connected with the electrode assembly 2, assembled with and insulated from the conductive cap plate 32. Correspondingly, the safety mechanism 31 comprises an inversion plate 311A electrically connected with the conductive cap plate 32, and when the internal gas pressure of the secondary battery reaches the predetermined value, the inversion plate 311A is inverted to electrically connect with the second electrode terminal 34. The inversion plate 311A is generally used for protecting the secondary battery when an accident arises in the secondary battery, and avoiding safety accident. However, the electrode plate (not shown) of the electrode assembly 2 expands during the normal use, which will increase the gas pressure in the internal space S, lead to the inversion plate 311A being inverted and in turn interrupt the electrical circuit between the electrode assembly 2 and an external device, and result in the failure of the secondary battery. The internal space S protruding outwardly of the secondary battery according to the present disclosure can prevent the increase of the gas pressure caused by the expansion of the electrode plate (not shown), avoid the inversion plate 311A being actuated in the normal state and prevent the failure of the secondary battery.

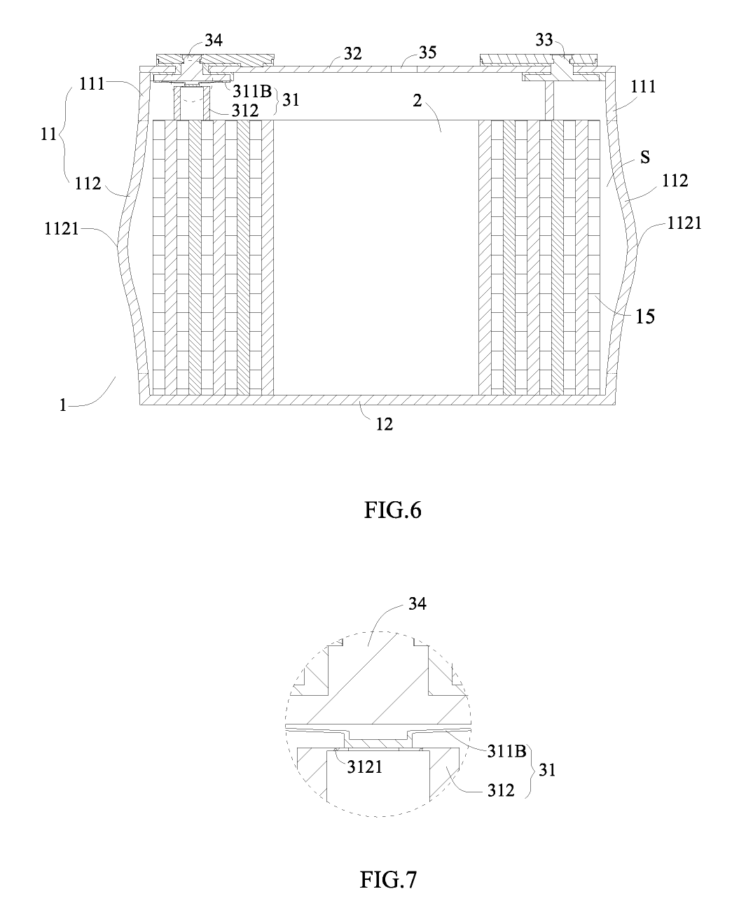

In an embodiment of the secondary battery according to the present disclosure, referring to FIG. 6 and FIG. 7, the cap assembly 3 further comprises a first electrode terminal 33 electrically connected with the electrode assembly 2 and a second electrode terminal 34 opposite to the first electrode terminal 33 in polarity. Correspondingly, the safety mechanism 31 comprises an inversion plate 311B and a conductive plate 312. The inversion plate 311B is electrically connected with the second electrode terminal 34. The conductive plate 312 electrically connects the inversion plate 311B with the electrode assembly 2 and has a notch 3121, the notch 3121 is arranged to encircle an electrically connecting portion between the conductive plate 312 and the inversion plate 311B from outside. When the internal gas pressure of the secondary battery reaches the predetermined value, the inversion plate 311B will be inverted and the conductive plate 312 will be torn along the notch 3121, which interrupts the electrical connection between the first electrode terminal 33 and the electrode assembly 2 of the secondary battery. The inversion plate 311B and the conductive plate 312 are generally used for protecting the secondary battery when an accident arises in the secondary battery, and avoiding safety accident. However, the electrode plate (not shown) of the electrode assembly 2 expands during the normal use, which will increase the gas pressure in the internal space S, lead to the inversion plate 311B being inverted and in turn interrupt the electrical connection between the electrode assembly 2 and the second electrode terminal 34, and result in the failure of the secondary battery. The internal space S protruding outwardly of the secondary battery according to the present disclosure can prevent the increase of the gas pressure caused by the expansion of the electrode plate (not shown), avoid the inversion plate 311B being actuated in the normal state and prevent the failure of the secondary battery.

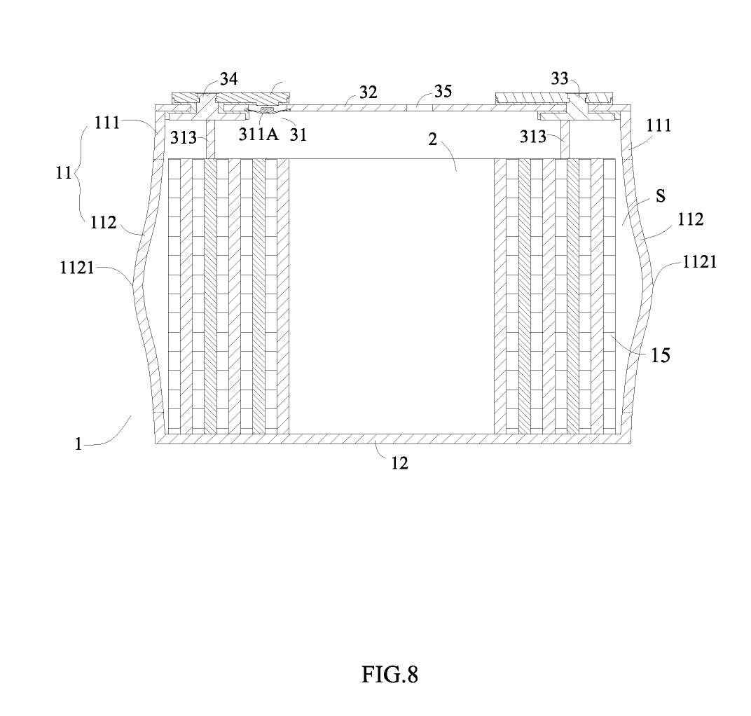

In an embodiment of the secondary battery according to the present disclosure, referring to FIG. 8, the cap assembly 3 further comprises: a conductive cap plate 32; a first electrode terminal 33 electrically connected with the conductive cap plate 32; and a second electrode terminal 34 opposite to the first electrode terminal 33 in polarity, assembled with and insulated from the conductive cap plate 32. Correspondingly, the safety mechanism 31 comprises: two fuses 313 respectively electrically connecting the first electrode terminal 33 with the electrode assembly 2 and electrically connecting the second electrode terminal 34 with the electrode assembly 2; and an inversion plate 311A electrically connected with the conductive cap plate 32 and provided below an electrically connecting piece. When the internal gas pressure of the battery reaches the predetermined value, the inversion plate 311A is inverted to electrically connect with the second electrode terminal 34, which will electrically connect the first electrode terminal 33 with the second electrode terminal 34 and lead to external short circuit which generates an electrical current to melt the fuse 313. The inversion plate 311A is generally used for protecting the secondary battery when an accident arises in the secondary battery, and avoiding safety accident. However, the electrode plate (not shown) of the electrode assembly 2 expands during the normal use, which will increase the gas pressure in the internal space S, and lead to the inversion plate 311A being inverted, the fuse 313 being melt by the generated electrical current, and result in failure of the secondary battery. The internal space S protruding outwardly of the secondary battery according to the present disclosure can prevent the increase of the gas pressure caused by the expansion of the electrode plate (not shown), avoid the inversion plate 311A being actuated in the normal state and prevent the failure of the secondary battery.

In an embodiment of the secondary battery according to the present disclosure, referring to FIG. 2, FIG. 5, FIG. 6 and FIG. 8, the cap assembly 3 further has an electrolyte injection hole 35.

In an embodiment of the secondary battery according to the present disclosure, the case 1 is a hard case.

In an embodiment of the secondary battery according to the present disclosure, the hard case is made of aluminum or steel.

Secondly, a manufacturing method for secondary battery according to a second aspect of the present disclosure will be described.

Referring to FIGS. 2-12, a manufacturing method for secondary battery according to the present disclosure is used for manufacturing the secondary battery according to the first aspect of the present disclosure, and comprises steps of: putting the electrode assembly 2 into the internal space S of the case 1 enclosed by the four side walls 11 and the bottom wall 12 of the case 1; providing the cap assembly 3 to the top of the case 1 and sealing the electrode assembly 2 in the space of the case 1; before sealing the electrolyte injection hole 35 of the cap assembly 3 of the secondary battery, injecting an inert gas into the internal space S of the case 1 via the electrolyte injection hole 35 and establishing a constant gas pressure in the internal space S; keeping a period of time, making a corresponding side wall 11 of the case 1 bulge outwardly and the space protrude correspondingly.

In the manufacturing method for secondary battery according to the present disclosure, the constant gas pressure in the internal space S of the case 1 can be established by injecting the inert gas, the corresponding side wall 11 of the case 1 bulges outwardly under the influence of the internal gas pressure, and the internal space S protrudes correspondingly, so that the secondary battery according to the first aspect of the present disclosure is obtained. Because the gas pressure applied on the side wall 11 is uniform, a convex surface of the side wall 11 is smooth and uniform.

In an embodiment of the manufacturing method for secondary battery according to the present disclosure, the constant pressure ranges from 30 KPa to 250 KPa.

In an embodiment of the manufacturing method for secondary battery according to the present disclosure, the time of the keeping for the constant gas pressure is 3 s˜60 s.

In an embodiment of the manufacturing method for secondary battery according to the present disclosure, when the corresponding side wall(s) 11 bulges outwardly, the cap assembly 3, the bottom wall 12 of the case 1 and the other side wall(s) 11 of the case 1 are limited from outside and will not bulge. According to the requirement of the secondary battery, when a side wall(s) 11 needs to bulge outwardly, a flat clamp abuts against the other side wall(s) 11 with no need for bulging, the bottom wall 12 and the cap assembly 3, and limits the other side wall(s) 11 with no need for bulging outwardly, the bottom wall 12 and the cap assembly 3 to bulge outwardly.

Finally, a manufacturing method for secondary battery according to a third aspect of the present disclosure will be described.

Referring to FIGS. 2-12, a manufacturing method for secondary battery according to the present disclosure is used for manufacturing the secondary battery according to the first aspect of the present disclosure, and comprises steps of: putting the electrode assembly 2 into the internal space S of the case 1 enclosed by the four side walls 11 and the bottom wall 12 of the case 1; providing the cap assembly 3 to the top of the case 1 and sealing the electrode assembly 2 in the internal space S of the case 1; after sealing the electrolyte injection hole 35 of the cap assembly 3 of the secondary battery, placing the secondary battery into a negative pressure box; keeping a period of time under a constant pressure, making a corresponding side wall 11 of the case 1 bulge outwardly and the space protrude correspondingly.

In the manufacturing method for secondary battery according to the present disclosure, the sealed secondary battery is positioned in the negative pressure box and kept under the constant pressure, so a force is applied on the corresponding side wall 11 due to the difference between the gas pressure in the case 1 and the gas pressure outside the case 1, which makes the corresponding side wall 11 of the case 1 bulge outwardly and makes the internal space S protrude correspondingly, so that the secondary battery according to the first aspect of the present disclosure is obtained. The force applied on the corresponding side wall 11 due to the difference between the gas pressure in the case 1 and the gas pressure outside the case 1 is uniform, so the convex surface of the side wall 11 is smooth and uniform.

In an embodiment of the manufacturing method for secondary battery according to the present disclosure, the pressure in the negative pressure box relative to the atmospheric pressure is −150 KPa-80 KPa.

In an embodiment of the manufacturing method for secondary battery according to the present disclosure, the time of the keeping for the secondary battery under the constant pressure is 15 min-200 min.

In an embodiment of the manufacturing method for secondary battery according to the present disclosure, when the corresponding side wall(s) 11 bulges outwardly, the cap assembly 3, the bottom wall 12 of the case 1 and the other side wall(s) 11 of the case 1 are limited from outside and will not bulge. According to the requirement of the secondary battery, when a side wall(s) 11 needs to bulge outwardly, a flat clamp abuts against the other side wall(s) 11 with no need for bulging, the bottom wall 12 and the cap assembly 3, and limits the other side wall(s) 11 with no need for bulging, the bottom wall 12 and the cap assembly 3 to bulge outwardly.

1. A secondary battery, comprising:
a case having four side walls and a bottom wall which enclose an internal space;
an electrode assembly received in the internal space of the case; and
a cap assembly provided to a top of the case and sealing the electrode assembly in the internal space, the cap assembly comprising a safety mechanism configured to make an electrical current not flow through the electrode assembly when a gas pressure in the internal space reaches a predetermined value;
wherein
at least one of the four side walls of the case bulges outwardly, and the internal space protrudes correspondingly.

2. The secondary battery according to claim 1, wherein
the side wall of the case bulging outwardly has an edge portion positioned at a periphery of the side wall and a bulging portion encircled by the edge portion.

3. The secondary battery according to claim 2, wherein the edge portion is in a shape of rectangular annulus with a constant width.

4. The secondary battery according to claim 3, wherein the width of the edge portion is 5 mm.

5. The secondary battery according to claim 2, wherein a protruding point of the bulging portion of the side wall bulging outwardly in the case is positioned in a centre of the bulging portion.

6. The secondary battery according to claim 5, wherein a perpendicular distance between the protruding point and a plane defined by a boundary between the bulging portion and the edge portion is defined as convexity, the convexity ranges from 0.1 mm to 3 mm.

7. The secondary battery according to claim 6, wherein at least two of the four side walls of the case bulge outwardly.

8. The secondary battery according to claim 7, wherein a difference between convexities of any two side walls bulging outwardly in the case is less than 0.5 mm.

9. The secondary battery according to claim 1, wherein a thickness of the side wall of the case ranges from 0.05 mm to 3 mm.

10. The secondary battery according to claim 1, wherein the electrode assembly is a wound-type electrode assembly, a laminated-type electrode assembly or a wound-laminated-combined type electrode assembly.

11. The secondary battery according to claim 1, wherein two of the four side walls of the case which are opposite to each other and larger than the other two of the four side walls of the case bulge outwardly.

12. The secondary battery according to claim 1, wherein
the cap assembly further comprises: a conductive cap plate; a first electrode terminal electrically connected with the electrode assembly and the conductive cap plate; and a second electrode terminal opposite to the first electrode terminal in polarity, electrically connected with the electrode assembly, assembled with and insulated from the conductive cap plate;
the safety mechanism comprises an inversion plate electrically connected with conductive cap plate, and when the internal gas pressure of the secondary battery reaches the predetermined value, the inversion plate is inverted to electrically connect with the second electrode terminal.

13. The secondary battery according to claim 1, wherein
the cap assembly further comprises a first electrode terminal electrically connected with the electrode assembly and a second electrode terminal opposite to the first electrode terminal in polarity;
the safety mechanism comprises an inversion plate and a conductive plate; the inversion plate is electrically connected with the second electrode terminal; the conductive plate electrically connects the inversion plate with the electrode assembly and has a notch, the notch is arranged to encircle an electrically connecting portion between the conductive plate and the inversion plate from outside;
when the internal gas pressure of the secondary battery reaches the predetermined value, the inversion plate will be inverted and the conductive plate will be torn along the notch, which interrupts the electrical connection between the second electrode terminal and the electrode assembly of the secondary battery.

14. The secondary battery according to claim 1, wherein
the cap assembly further comprises: a conductive cap plate; a first electrode terminal electrically connected with the conductive cap plate; and a second electrode terminal opposite to the first electrode terminal in polarity, assembled with and insulated from the conductive cap plate;
the safety mechanism comprises: two fuses respectively electrically connecting the first electrode terminal with the electrode assembly and electrically connecting the second electrode terminal with the electrode assembly; and an inversion plate electrically connected with the conductive cap plate and provided below an electrically connecting piece;
when the internal gas pressure of the battery reaches the predetermined value, the inversion plate is inverted to electrically connect with the second electrode terminal, which will electrically connect the first electrode terminal with the second electrode terminal and lead to external short circuit which generates an electrical current to melt the fuse.

15. The secondary battery according to claim 1, wherein the cap assembly further has an electrolyte injection hole.

16. The secondary battery according to claim 1, wherein the case is a hard case.

17. The secondary battery according to claim 16, wherein the hard case is made of aluminum or steel.

18. A manufacturing method for secondary battery, comprising steps of:
putting an electrode assembly of a secondary battery into an internal space of a case of the secondary battery enclosed by four side walls and a bottom wall of the case;
providing a cap assembly of the secondary battery to a top of the case and sealing the electrode assembly in the internal space of the case, the cap assembly comprising a safety mechanism configured to make an electrical current not flow through the electrode assembly when a gas pressure in the internal space reaches a predetermined value;
before sealing an electrolyte injection hole of the cap assembly of the secondary battery, injecting an inert gas into the internal space of the case via the electrolyte injection hole and establishing a constant gas pressure in the internal space;
keeping a period of time, making a corresponding side wall of the case bulge outwardly and the internal space protrude correspondingly.

19-21. (canceled)

22. A manufacturing method for secondary battery, comprising steps of:
putting an electrode assembly of a secondary battery into an internal space of a case of the secondary battery enclosed by four side walls and a bottom wall of the case;
providing a cap assembly of the secondary battery to a top of the case and sealing the electrode assembly in the internal space of the case, the cap assembly comprising a safety mechanism configured to make an electrical current not flow through the electrode assembly when a gas pressure in the internal space reaches a predetermined value;
after sealing an electrolyte injection hole of the cap assembly of the secondary battery, placing the secondary battery into a negative pressure box;
keeping a period of time under a constant pressure, making a corresponding side wall of the case bulge outwardly and the internal space protrude correspondingly.

23-25. (canceled)
